(19) United States
(12) Patent Application Publication
(10) Pub. No.: US 2019/0304716 A1
(43) Pub. Date: Oct. 3, 2019

(54) KEYSWITCH ASSEMBLY

(71) Applicants: LITE-ON Technology (Chang Zhou) Co., LTD., Jiangsu Province (CN); LITE-ON Technology Corporation, Taipei City (TW)

(72) Inventors: Bing-Wei Zhang, Jiangsu Province (CN); Xiao-Qiang Liang, Jiangsu Province (CN); Jia-Xun Wu, Taipei City (TW); Lei Shi, Jiangsu Province (CN)

(73) Assignees: LITE-ON Technology (Chang Zhou) Co., LTD, Jiangsu Province (CN); LITE-ON Technology Corporation, Taipei City (TW)

(21) Appl. No.: 16/368,349

(22) Filed: Mar. 28, 2019

(30) Foreign Application Priority Data
Mar. 29, 2018 (CN) 201820438380.0

(51) Int. Cl. H01H 13/14; H01H 3/12; H01H 13/20

(52) U.S. Cl. CPC H01H 13/14; H01H 13/20; H01H 3/125

(57) ABSTRACT

A keyswitch assembly is provided. The keyswitch assembly includes a base plate, at least one pressing mechanism disposed on the base plate, a plurality of elastic supporting members disposed on the base plate, and a keycap covering the at least one pressing mechanism and the plurality of elastic supporting members. In the embodiments, a plurality of elastic supporting members is disposed at equal intervals to support the keycap. By way of such configuration, the user experiences the same or similar hand feeling when pressing any point of the keycap. There is no difference in the pressing feel due for pressing the middle or two ends of the keycap. Meanwhile, the problem of the poor electrical conduction resulted from the deformation of the keycap may be avoided.

### CROSS REFERENCE TO RELATED APPLICATION

This application claims the priority benefit of Chinese Patent Application Serial Number 201820438380.0, filed on Mar. 29, 2018, the full disclosure of which is incorporated herein by reference.

### BACKGROUND

### Technical Field

This present invention generally relates to the field of keyswitch and, more particularly, to the structure of a keyswitch assembly.

### Related Art

Keyboard are generally used for inputting texts. According to the mechanism design under a keyswitch of a keyboard, the keyboard can be generally divided into two categories, which are a thin film keyboard and a mechanical keyboard respectively. The pressing feeling of a general thin film keyboard lies in the cooperation of the mechanical structure between the rubber cap and the scissor foot below the keyswitch. When the user presses the keyswitch, the rubber cap is compressed by the pressing force, so that the button is pressed down. While the user stops pressing the keyswitch, the restoring force of the rubber cap would cause a rebound, which causes the keycap to provide the restoring force, so as to raise the keyswitch. Accordingly, the pressing feeling is formed. The pressing feeling of a mechanical keyboard lies in the cooperation of the shaft center and the spring structure under the keyswitch, and accordingly, the pressing feeling is through the combination of pressing force and restoring force of the spring.

However, the above-mentioned keyswitch structure has a common disadvantage, that is, when a keyswitch has a large pressing area (such as a space bar), the restoring force of the keyswitch is insufficient, or the pressing feeling on the middle surface of the keyswitch is inconsistent with the pressing feeling at both ends of the keyswitch. Thus, the pressing feeling is poor. Also, the corner of the keyswitch is easily deformed due to the insufficient supporting force, resulting in poor electrical connection of the keyswitch and bad experience of using the keyboard.

### SUMMARY

The embodiments of the present invention provides a keyswitch assembly to solve the problems of deformation, poor electrical conduction or poor pressing feeling of the keyswitch in the prior art.

In one embodiment, the keyswitch assembly includes a base plate, at least one pressing mechanism disposed on the base plate, a plurality of elastic supporting members disposed on the base plate, and a keycap covering the at least one pressing mechanism and the plurality of elastic supporting members.

In the embodiments, a plurality of elastic supporting members is disposed in the keyswitch assembly to support the keycap. By way of such configuration, the user experiences the same or similar hand feeling when pressing any point of the keycap. Thus, there is no difference in the pressing feel due for pressing the middle or two ends of the keycap. Meanwhile, the problem of the poor electrical conduction resulted from the deformation of the keycap may be avoided.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows the perspective view of the keyswitch assembly according to a first embodiment of the present invention;

FIG. 2 shows an enlarged cross-sectional along the line AA′ in FIG. 1;

FIG. 3 shows an exploded view of the structure of the keyswitch assembly of the first embodiment of the present application;

FIG. 4 shows the combination of the structure of the keyswitch assembly of the first embodiment of the present application;

FIG. 5 shows the combination of the structure of the keyswitch assembly of the second embodiment of the present application; and

FIG. 6 shows the combination of the structure of the keyswitch assembly of the third embodiment of the present application.

### DETAILED DESCRIPTION OF THE EMBODIMENTS

The present invention will now be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that this present invention will be thorough and complete, and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals is used to refer to the same or similar elements throughout the invention.

The present invention provides a keyswitch assembly, which demonstrates as one of the keys in the keyboard. The plurality of elastic supporting members of the keyswitch assembly provide a uniform supporting force for the keycap. When pressing a keycap having a large pressing area (such as the space bar), there will be no difference of the pressing feeling no matter where the user presses the keycap. Also, the corner of the keycap will not be deformed by pressing, and each elastic supporting member Can be electrically connected to the circuit board.

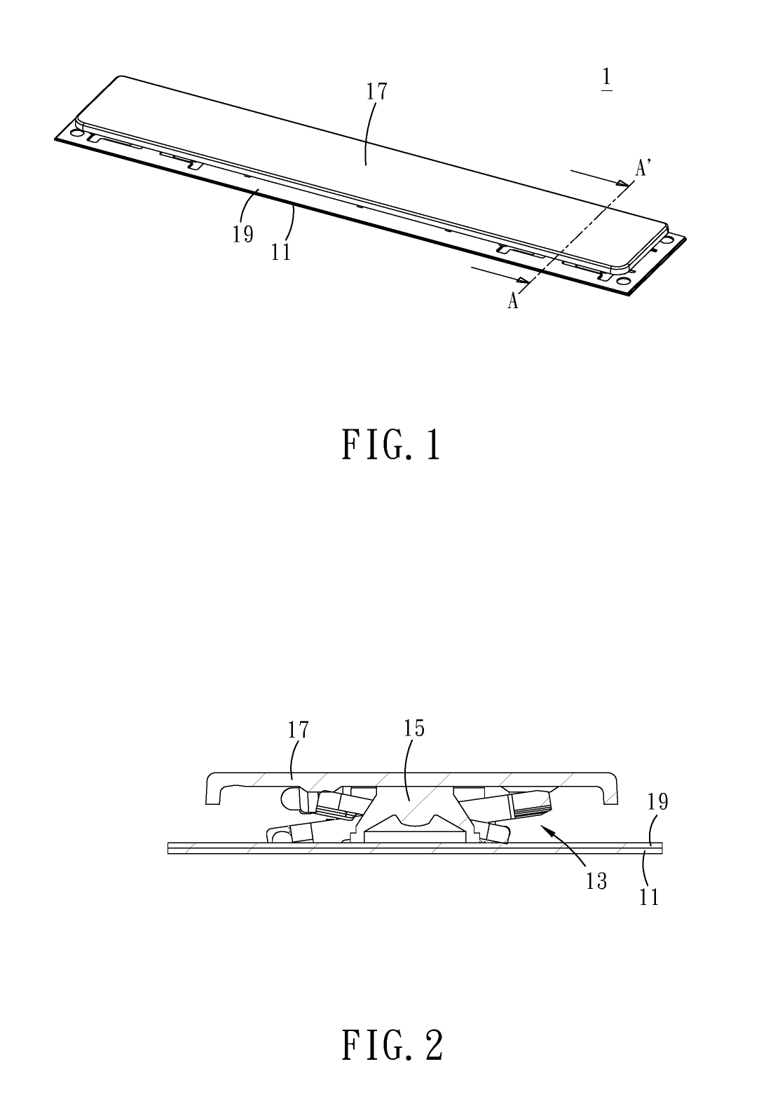

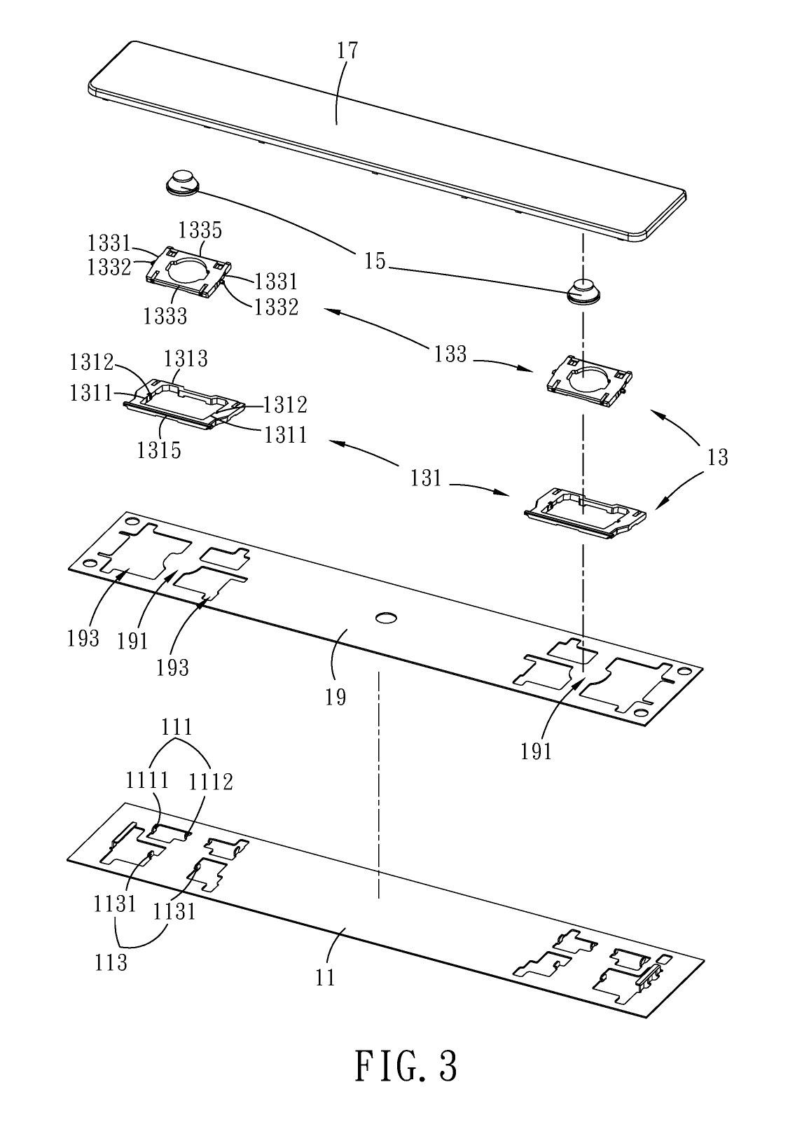

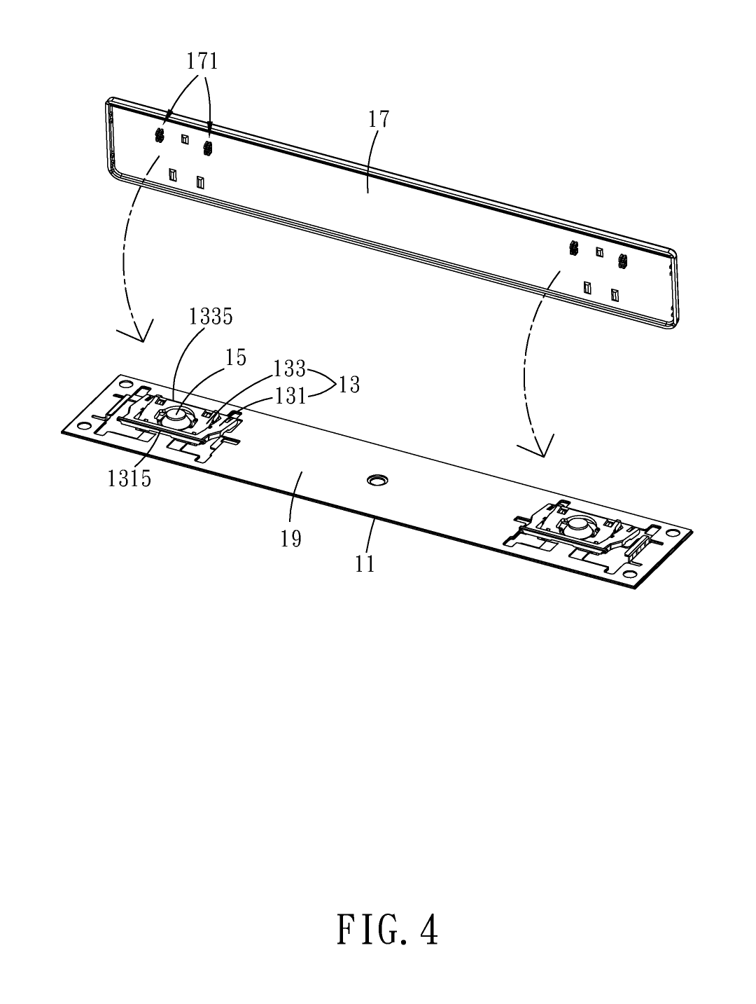

Refer to FIG. 1, FIG. 2, FIG. 3 and FIG. 4, which shows the perspective view, i.e. the enlarged cross-sectional view along the line AA′ in FIG. 1; the exploded view and the combination of the structure of the keyswitch assembly of the first embodiment of the present application. As shown in the figure, the keyswitch 1 in this embodiment includes a base plate 11, at least one pressing mechanism 13, a plurality of elastic supporting members 15, and a keycap 17. The at least one pressing mechanism 13 is disposed on the base plate 11. The plurality of elastic supporting members 15 spaced with intervals is disposed on the base plate 11, and corresponds to the plurality of pressing mechanisms 13. The keycap 17 covers the at least one pressing mechanism 13 and the plurality of elastic supporting members 15. The plurality of elastic supporting members supports the keycap 17. A circuit board 19 is further disposed on the surface facing the keycap 17 of the base plate 11. The circuit board 19 includes a plurality of switches 191 corresponding to the plurality of elastic supporting members 15. The plurality of elastic supporting members 15 are disposed on the plurality of switches 191.

In this embodiment, the number of the pressing mechanism 13 and the elastic supporting member 15 are two. The two pressing mechanisms 13 are symmetrically disposed on the base plate 11. The two elastic supporting members 15 are respectively dispose in the corresponding pressing mechanisms 13. The detailed structure of the base plate 11, the pressing mechanism 13, and the keycap 17 will be further described below. The base plate 11 includes a fixing portion 111 and a limiting portion 113 at the position corresponding to the pressing mechanism 13. The fixing portion 111 is disposed at one side of the limiting portion 113. The fixing portion 111 is a combined structure having a plurality of fixing hooks 1111 and a plurality of fixing blocks 1112. The limiting portion 113 includes a plurality of limiting hooks 1131. The circuit board 19 disposed on the base plate 19 includes a plurality of hollow portions 193. The fixing portion 111 and the limiting portion 113 pass through the hollow portion 193. That is the plurality of fixing hooks 1111, the plurality of fixing blocks 1112, and the plurality of limiting hooks 1131 pass through the hollow portion 193.

The pressing mechanism 13 further includes a first bracket 131 and a second bracket 133. The two outer sides 1331 of the second bracket 133 are pivotally disposed on two inner sides 1311 of the first bracket 131 respectively. That is the first bracket 131 and the second bracket 133 are alternately arranged. The two outer sides 1331 of the second bracket 133 respectively includes bumps 1332. The two inner sides 1311 of the first bracket 131 respectively includes notches 1312. The bumps 1332 are fitted in the notches 1312. The first bracket 131 and the second bracket 133 are relatively pivotable. The first bracket 131 further includes a first outer side 1313 and a second outer side 1315. The second bracket 133 further includes a first inner side 1333 and a second inner side 1335. The first outer side 1313 and the first inner side 1333 are disposed on the base plate 11. The second outer side 1315 and the second inner side 1335 are disposed to the keycap 17.

The first outer side 1313 of the first bracket 131 is disposed to the fixing portion 111. That is the inner side of the first outer side 1313 hooks to the plurality of fixed hooks 1111. The outer side of the first outer side 1313 is obstructed by the plurality of fixing blocks 1112. The first bracket 131 is pivoted to the base plate 11. The first inner side 1333 of the second bracket 133 engages with the limiting portion 113. That is, the inner side of the first inner side 1333 is obstructed by the limit hook 1131, such that the first inner side 1333 of the second bracket 133 is restricted to move inwardly.

Refer to FIG. 4. The inside of the keycap 17 has a buckle portion 171 corresponding to the second outer side 1315 of the pressing mechanism 13. The second outer side 1315 is fitted to the buckle portion 171. The first bracket 131 can pivot relative to the keycap 17. The second inner side 1335 of the pressing mechanism 13 directly abuts against the inner side of the keycap 17. The elastic supporting member 15 is located in the second bracket 133.

When the keyswitch assembly 1 of this embodiment is in use, the user presses the keycap 17, and the keycap 17 moves downward and drives the pressing mechanism 13 and the elastic supporting member 15. As the keycap 17 moves downward, the keycap 17 drives the first bracket 131 of the pressing mechanism 13 to pivot relative to the second bracket 133 of the pressing mechanism 13, such that a cross configuration of the first bracket 131 and the second bracket 133 transforms into an overlap configuration of the first bracket 131 and the second bracket 133. At the same time, the elastic supporting member 15 is compressed by the keycap 17 downwardly to contact the switches 191 of the circuit board 19 on the base plate 11, so as to achieve electrical conduction and complete one input of the keyswitch. When the elastic supporting member 15 is compressed, another upward supporting force of the keycap 17 can also be provided, and the deformation of the keycap 17 due to pressing can be effectively prevented. When the user stops pressing the keycap 17, the compressed elastic supporting member 15 restores to its original state. The elastic force of the elastic supporting member 15 drives the keycap 17 to move upward. The keycap 17 drives the first bracket 131 and the second bracket 133 of the pressing mechanism 13 to return to the original cross configuration. By way of such configuration, the pressing force of pressing the keycap 17 and the restoring force that the elastic supporting member 15 restores the keycap 17 are the source of the pressing feeling.

The two elastic supporting member 15 of the keyswitch assemblies 1 in this embodiment are disposed with intervals under the keycap 17. The two elastic supporting members 15 uniformly provide the supporting force for the keycap 17, to provide sufficient restoring force for the keycap 17. When the user presses any spot/area of the surface of the keycap 17, the pressing feeling is the same throughout the entire keycap 17, and there should be no difference of the pressing feeling while directly pressing the middle or two ends of the keycap 17. The two pressing mechanisms 13 are connected between the base plate 11 and the keycap 17 to maintain the stability of the rising and lowering of the keycap 17. The number of the pressing mechanisms 13 may be two or more. The number of the elastic supporting members 15 should be the same as the number of the pressing mechanisms 13. The plurality of the elastic supporting members 15 may be disposed on the base plate 11 at equal intervals or at different intervals, which is not limiting the scope of the embodiment. In the embodiment that the plurality of the elastic supporting members 15 are disposed on the base plate 11 at equal intervals, the plurality of elastic supporting members 15 uniformly provide sufficient supporting force for multiple parts of the keycap 17. In other words, the parts located between two ends of the keycap 17 and the intermediate part of the keycap 17 may be supported uniformly by the supporting force. The keyswitch assembly 1 of the present embodiment can also be provided with a single pressing mechanism 13 and a plurality of elastic supporting members 15 are disposed with intervals in the pressing mechanism 13, which will not be described again. The plurality of the elastic supporting members 15 may be disposed inside the pressing mechanism 13 at equal intervals or at different intervals.

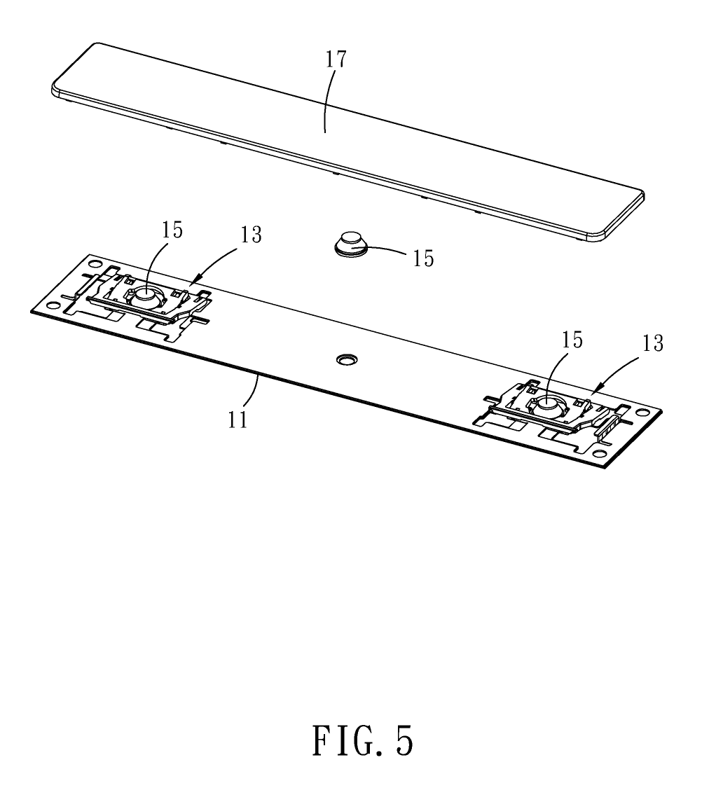

FIG. 5 shows the combination of the structure of the keyswitch assembly of the second embodiment of the present application. As shown in the figure, the difference between the present embodiment and the first embodiment is that the number of the pressing mechanisms 13 of the keyswitch assembly of the present embodiment is two, and the number of the elastic supporting members 15 is three. The pressing mechanisms 13 are also symmetrically disposed on the base plate 11, and two of the three elastic supporting members 15 are respectively disposed in the corresponding pressing mechanisms 13. The remaining elastic supporting member 15 is disposed between the two elastic supporting members 15. The three elastic supporting members 15 are disposed on the base plate 11 at equal intervals. The keyswitch assembly 1 of the present embodiment significantly enhances the support in the middle of the keycap 17 with respect to the keyswitch assembly of the first embodiment. Certainly, it is also possible to dispose one or more elastic supporting members 15 between the two pressing mechanisms 13. The number of the pressing mechanism 13 and the elastic support 15 is determined by the area of the keycap 17, which is not limiting the scope of the embodiment.

It can be seen from the above embodiment that the plurality of the elastic supporting members 15 can be disposed at equal intervals (as shown in FIG. 5) or at different intervals on the base plate 11, and a plurality of elastic supporting members 15 are disposed inside or/and outside the at least one pressing mechanism 13. The manner in which the plurality of elastic supporting members 15 and the pressing mechanism 13 are arranged can be adaptively adjusted due to different user requirements, which is not limiting the scope of all the embodiments.

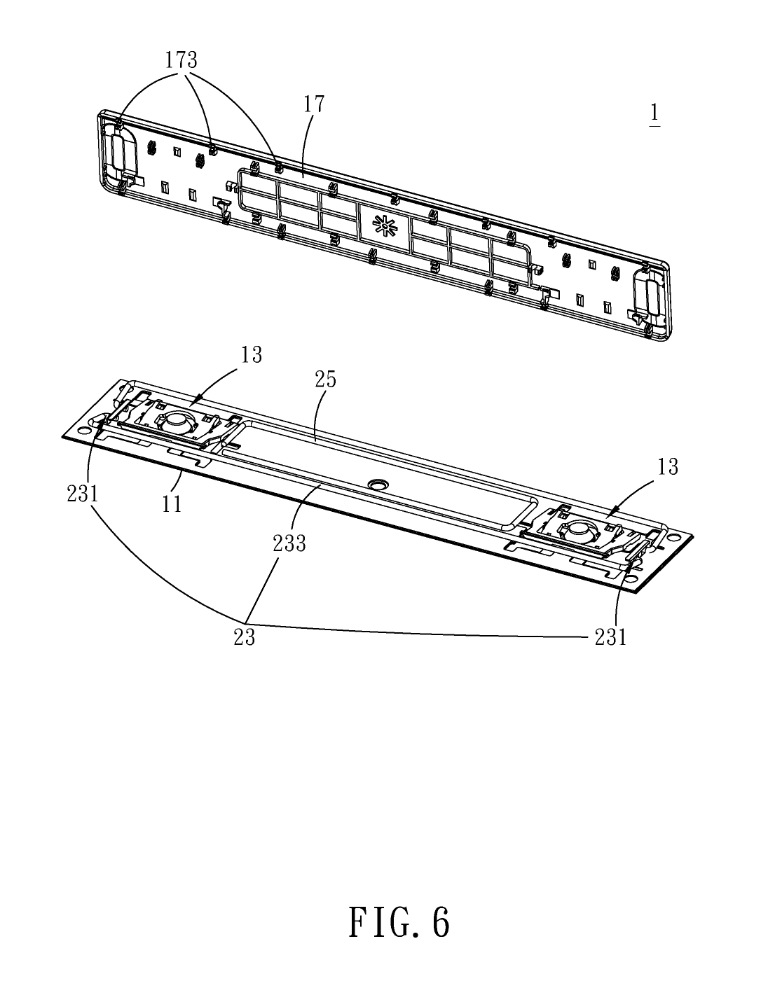

FIG. 6 shows the combination of the structure of the keyswitch assembly of the third embodiment of the present application. The difference between the present embodiment and the first embodiment is that the keyswitch assembly of the present embodiment further includes a balance supporting frame 23 and a supporting frame 25. The balance supporting frame 23 is connected between the base plate 11 and the keycap 17. The balance supporting frame 23 includes two fixing portions 231 and two elastic brackets 233. The two fixing portions 231 are disposed at two ends (that is, at two opposite ends of the button structure 1) of the base plate 11. In the present embodiment, the two fixing portions 231 are respectively disposed on two sides, which are opposite to each other corresponding to the center of the pressing mechanism 13, of the base plate 11. Two ends of each of the elastic brackets 233 are pivotally connected to the two fixing portions 231, and are also connected to the keycap 17. Each of the elastic brackets 233 is pivoted relative to the two fixing portions 231. When the user presses one end of the keycap 17, the pressed end of the keycap 17 moves downward and drives the two elastic brackets 233 to pivot relative to the two fixing portions 231, so as to drive the other end of the keycap 17 to move downward together. This shows that the balance supporting frame 23 can simultaneously drive the surface of the keycap 17 to move downward. Certainly, the balance supporting frame 23 can simultaneously drive the surface of the keycap 17 to move upwards, thereby preventing the keycap 17 from being unbalanced during the movement.

In addition, the two fixing portions 231 of the balance supporting frame 23 can be selectively disposed on one side corresponding to the pressing mechanism 13. In other words, the two fixing portions 231 can be selectively disposed on the outer side of the pressing mechanism 13 (as shown in FIG. 6) or on the inner side of the pressing mechanism 13. Both configurations can achieve the above effects. The above effects can also be achieved by only disposing a single elastic support 233 of the balance supporting frame 23. The supporting frame 25 is disposed on the surface of the keycap 17 facing the base plate 11 and disposed at the periphery of the two pressing mechanisms, merely avoiding the pressing mechanisms and the elastic supporting members. The keycap 17 has an outer latching member 173 corresponding to the elastic bracket 233. The elastic bracket 233 is latched to the outer latching member 173 of the keycap 17. The supporting frame 25 mainly increases the strength of the keycap 17 to avoid deformation resulting from the pressing.

In summary, according to the embodiments, a plurality of elastic supporting members are disposed in the keyswitch assembly to support the keycap. By way of such configuration, the user experiences the same or similar pressing feeling when pressing any spot/area of the keycap. Thus, there is no difference of the pressing feeling while pressing the middle or two ends of the keycap. In the meanwhile, the problem of the poor electrical conduction resulted from the deformation of the keycap may be avoided.

It is to be understood that the term “comprises”, “comprising”, or any other variants thereof, is intended to encompass a non-exclusive inclusion, such that a process, method, article, or device of a series of elements not only includes those elements but also includes other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. A keyswitch assembly, comprising:
a base plate;
at least one pressing mechanism disposed on the base plate;
a plurality of elastic supporting members disposed on the base plate; and
a keycap covering the at least one pressing mechanism and the plurality of elastic supporting members.

2. The keyswitch assembly according to claim 1, wherein each of the pressing mechanisms comprises a scissors-like.

3. The keyswitch assembly according to claim 2, wherein each of the pressing mechanisms comprises a first bracket and a second bracket; two outer sides of the second bracket are pivotally disposed on two inner sides of the first bracket respectively; the first bracket further comprises a first outer side and a second outer side, and the second bracket further comprises a first inner side and a second inner side; the first outer side and the first inner side are disposed on the base plate; the second outer side and the second inner side are disposed to the keycap; the base plate further comprises a fixing portion and a limiting portion at a position corresponding to the pressing mechanism; the first outer side of the first bracket is disposed to the fixing portion, and the first inner side of the second bracket is engaged with the limiting portion.

4. The keyswitch assembly according to claim 3, wherein the two outer sides of the second bracket respectively comprises bumps; the two inner sides of the first bracket respectively comprises notches; the bumps are fitted in the notches.

5. The keyswitch assembly according to claim 3, wherein the keycap comprises a buckle portion corresponding to the second outer side of each of the pressing mechanisms; the second outer side is fitted to the buckle portion.

6. The keyswitch assembly according to claim 3, wherein the base plate further comprises a circuit board on the surface facing the keycap; the circuit board comprises a plurality of switches corresponding to the plurality of elastic supporting members.

7. The keyswitch assembly according to claim 6, wherein the circuit board comprises a plurality of hollow portions; each of the hollow portions corresponds to the fixing portion and the limiting portion.

8. The keyswitch assembly according to claim 1, further comprising a balance supporting frame, the balance supporting frame being connected between the base plate and the keycap.

9. The keyswitch assembly according to claim 8, wherein the balance supporting frame comprises two fixing portions and at least one elastic bracket; the two fixing portions are disposed on the base plate; two ends of the at least one elastic bracket are pivotally connected to the corresponding two fixing portions; the at least one of the elastic brackets is connected to the keycap.

10. The keyswitch assembly according to claim 1, further comprising a supporting frame disposed on a surface of the keycap facing the base plate and located at a periphery of the at least one pressing mechanisms.

11. The keyswitch assembly according to claim 1, wherein the plurality of the elastic supporting members are disposed at equal intervals.

12. The keyswitch assembly according to claim 1, wherein the plurality of the elastic supporting members are located inside or/and outside of the at least one pressing mechanisms.
